(19) United States
(12) Patent Application Publication
(10) Pub. No.: US 2023/0211696 A1
(43) Pub. Date: Jul. 6, 2023

(54) ELECTRIC VEHICLE CHARGING MANAGEMENT METHODS AND SYSTEMS BASED ON CHARGING DEMAND OF ELECTRIC VEHICLE

(71) Applicant: Noodoe Corporation, Taipei City (TW)

(72) Inventor: John C. WANG, Taipei City (TW)

(21) Appl. No.: 17/976,907

(22) Filed: Oct. 31, 2022

(30) Foreign Application Priority Data
Dec. 30, 2021 (TW) 110149521

(51) Int. Cl. B60L 53/68; B60L 53/66; B60L 53/30; B60L 53/67; B60L 53/63; G06Q 50/06

(52) U.S. Cl. CPC B60L 53/68; B60L 53/66; B60L 53/305; B60L 53/67; B60L 53/63; G06Q 50/06

(57) ABSTRACT

Electric vehicle charging management methods and systems based on charging demand of electric vehicle are provided. First, energy management scheme recording power distribution logic for controlling charging operations in each of electric vehicle charging stations is provided on server. First charging request corresponding to first electric vehicle is received from first electric vehicle charging station or first mobile device, and first charging parameter with a required power and a stay period corresponding to first charging request is received. The energy management scheme is executed according to required power and stay period to determine target power parameter value of first charging operation of first electric vehicle charging station, wherein first electric vehicle charging station outputs power to first electric vehicle based on target power parameter value, where first charging operation is performed during stay period, and total power output to first electric vehicle is greater than required power.

### BACKGROUND OF THE INVENTION

### Field of the Invention

The disclosure relates generally to charging management methods and systems for electric vehicles, and, more particularly to charging management methods and systems for electric vehicles that can flexibly execute energy management schemes according to charging demands of different electric vehicles.

### Description of the Related Art

Recently, with the rising awareness of environmental protection and electric vehicle technology advances, the development of electric vehicles powered by electrical energy to replace traditional vehicles powered by fossil fuels has gradually become an important goal in the automotive field, thus making electric vehicles become more and more popular. In order to increase the range and willingness to use electric vehicles, many countries or cities have begun to set up charging stations in public places to provide electricity to electric vehicles, and have also begun to plan the deployment of a large number of charging stations in urban areas or scenic areas, so as to make the charging of electric vehicles more convenient.

Generally, the power equipment in the most field has already been constructed. To update the power equipment, such as the capacity of the electric panel, it is expensive and the construction time is long. Often, the number of charging stations that can be installed in a single charging field is limited by the existing maximum load capacity of the field. Therefore, in the case of limited charging stations, the drivers of electric vehicles may have to wait since the charging station may be in use, or need to find other nearby charging stations for charging operations, which causes inconvenience in use, and drives the willingness to adopt electric vehicles.

Therefore, under the premise of not updating the power equipment, some charging fields can introduce load adjustment operations to increase the number of charging stations that can be installed in the field. In the load adjustment operation, by reducing the power output of individual charging stations, more electric vehicles can be charged in the charging field at the same time. On the other hand, since the power provided by the power companies and the power grids is limited, the issue of the power required for electric vehicle charging operations being an impact of the power grids has also become critical for the industry. For example, in some industrial applications, a scheduled charging mechanism can be used to utilize the off-peak period of power consumption for charging, so as to achieve the purpose of reducing grid impact. However, there will be various needs for different industries, and there will be temporary and special demands at the same time. Therefore, how to maintain flexibility in the charging management of electric vehicles will become an important key to the development of electric vehicles.

### BRIEF SUMMARY OF THE INVENTION

In an embodiment of an electric vehicle charging management method based on charging demand of electric vehicle, which is applicable to a charging field including a plurality of electric vehicle charging stations, and the electric vehicle charging stations are connected to a server through a network, the server provides at least one energy management scheme, wherein the energy management scheme records a power distribution logic for controlling a charging operation for each of the electric vehicle charging stations. Then, a first charging request corresponding to a first electric vehicle is received from a first electric vehicle charging station among the electric vehicle charging stations or a first mobile device and a first charging parameter corresponding to the first charging request is obtained, wherein the first charging parameter includes at least a required power and a stay period. The energy management scheme is executed according to the required power and the stay period to determine a target power parameter value of a first charging operation of the first electric vehicle charging station, wherein the first electric vehicle charging station outputs power to the first electric vehicle based on the target power parameter value, wherein the first charging operation is performed during the stay period, and the total power output from the first electric vehicle charging station to the first electric vehicle is greater than the required power.

An embodiment of an electric vehicle charging management system based on charging demand of electric vehicle for use in a charging field comprises a plurality of electric vehicle charging stations, and a server. Each electric vehicle charging station has a network connection capability, and connects to the server through a network. The server comprises at least one energy management scheme, which records a power distribution logic for controlling a charging operation for each of the electric vehicle charging stations. The server receives a first charging request corresponding to a first electric vehicle from a first electric vehicle charging station among the electric vehicle charging stations or a first mobile device and obtains a first charging parameter corresponding to the first charging request, wherein the first charging parameter includes at least a required power and a stay period. The server executes the energy management scheme according to the required power and the stay period to determine a target power parameter value of a first charging operation of the first electric vehicle charging station, wherein the first electric vehicle charging station outputs power to the first electric vehicle based on the target power parameter value, wherein the first charging operation is performed during the stay period, and the total power output from the first electric vehicle charging station to the first electric vehicle is greater than the required power.

In some embodiments, the server further executes the energy management scheme, thus to determine the corresponding target power parameter value for the charging operation of each electric vehicle charging station, and perform the charging operations accordingly for respective electric vehicles through the respective electric vehicle charging stations. The server further adjusts the corresponding target power parameter value determined by the charging operation of each electric vehicle charging station according to the required power and the stay period corresponding to the first charging parameter. Each electric vehicle charging station respectively performs the respective charging operation based on the adjusted target power parameter value.

In some embodiments, the server further determines a charging influence corresponding to each electric vehicle charging station according to the first charging parameter, wherein the charging influence includes at least a reduction in power of the charging operation corresponding to each electric vehicle charging station, and determines a charging rate corresponding to the first charging operation according to the charging influence.

In some embodiments, the server further decreases the charging rate corresponding to the charging operation of each electric vehicle charging station according to the charging influence.

In some embodiments, the first charging parameter of the first electric vehicle is received through a user interface of the first mobile device. The first mobile device then transmits identification data corresponding to the first electric vehicle charging station and the first charging parameter to the server through the network.

In some embodiments, the server further connects to a route planning system to obtain a travel route and an estimated travel time corresponding to the first electric vehicle, and determines the required power and the stay period of the first charging parameter according to the travel route and the estimated travel time.

Electric vehicle charging management system based on charging demand of electric vehicle may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an electric vehicle charging management system based on charging demand of electric vehicle of the invention;

FIG. 2 is a schematic diagram illustrating an embodiment of an electric vehicle charging station of the invention;

FIG. 3 is a schematic diagram illustrating an embodiment of a server of the invention;

FIG. 4 is a flowchart of an embodiment of an electric vehicle charging management method based on charging demand of electric vehicle of the invention;

FIG. 5 is a flowchart of another embodiment of an electric vehicle charging management method based on charging demand of electric vehicle of the invention;

FIG. 6 is a flowchart of another embodiment of an electric vehicle charging management method based on charging demand of electric vehicle of the invention;

FIG. 7 is a flowchart of an embodiment of a method for obtaining charging parameters of the invention; and

FIG. 8 is a flowchart of another embodiment of a method for obtaining charging parameters of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

FIG. 1 is a schematic diagram illustrating an embodiment of an electric vehicle charging management system based on charging demand of electric vehicle of the invention. The electric vehicle charging management system based on charging demand of electric vehicle 100 can be used in a charging filed 110 with a plurality of electric vehicle charging stations. It is noted that, the charging filed 110 has a power limitation. As shown in FIG. 1, the electric vehicle charging management system based on charging demand of electric vehicle 100 comprises a plurality of electric vehicle charging stations, such as a first charging station 112 and a second charging station 114, and a server 130 respectively connected with the first charging station 112 and the second charging station 114 via a network 120. The respective charging stations can provide electric vehicles (EV1, EV2) for charging operations. In some embodiments, the network 120 may be a wired network, a telecommunication network, and a wireless network, such as a Wi-Fi network. The server 130 can respectively receive various data from the first charging station 112 and the second charging station 114, and transmit related signals to the first charging station 112 and the second charging station 114. The first charging station 112 and the second charging station 114 can perform related operations according to the signals received from the server 130. For example, when the electric vehicle EV1 is coupled to the first charging station 112 through a charging gun of the first charging station 112 for a charging operation, the first charging station 112 can continuously transmit charging information corresponding the charging operation of the electric vehicle EV1 via the network 120, and the server 130 can receive the charging information of the corresponding charging operation from the first charging station 112 via the network 120. Similarly, when the electric vehicle EV2 is coupled to the second charging station 114 through a charging gun of the second charging station 114 to perform a charging operation, the second charging station 114 can continuously transmit the charging information corresponding the charging operation of the electric vehicle EV2 via the network 120, and the server 130 can receive the charging information of the corresponding charging operation from the second charging station 114 via the network 120. In some embodiments, the charging information may include at least a charging start time, a charging period, an output power, and/or related information indicating whether a load adjustment operation is being performed. The server 130 can know the usage status of the corresponding electric vehicle charging station according to the charging information.

It is noted that the user can connect the electric vehicle EV1 and the first charging station 112 to each other, such as inserting a charging gun into the charging port of the electric vehicle to send a charging request corresponding to the first charging station 112 to use the first charging station 112. The first charging station 112 performs a charging operation for the electric vehicle EV1. Similarly, the user can connect the electric vehicle EV2 and the second charging station 114 to each other, such as inserting a charging gun into the charging port of the electric vehicle to send a charging request corresponding to the second charging station 114 to use the second charging station 114. It is understood that, in some embodiments, the server 130 may directly or indirectly receive a charging request from a mobile device (not shown in FIG. 1) of the owner of the electric vehicle EV1, and generate a charging authorization command based on the charging request and transmit it to the first charging station 112 via the network 120, so that the first charging station 112 outputs power to the electric vehicle EV1, such as an electric scooter or an electric car, which is electrically connected to it, or prohibits the first charging station 112 from outputting power to the electric vehicle EV1. It is reminded that, in some embodiments, the charging request may be accompanied by an identity authentication and/or a payment mechanism, and the charging authorization command will only be generated after the identity authentication and/or payment mechanism is completed. In some embodiments, the user of the electric vehicle EV1 can use his/her mobile device to download and install an application to generate a charging request through the user interface of the application. In some embodiments, the user can scan a Quick Response Code (QR code) on the first charging station 112 through the scanning function of the application to generate the above-mentioned charging request, thereby starting a charging operation. In some embodiments, the user can select a specific charging station through the application and execute an activation function to generate the above-mentioned charging request, thereby starting a charging operation. It is understood that, in some embodiments, the owner of the electric vehicle EV1 can use an RFID card to approach an induction area (not shown in FIG. 1) on the first charging station 112 to generate a corresponding charging request, and sent it to the server 130 via the network 120. It is reminded that, in some embodiments, each user can have an RFID card.

It is noted that, the device corresponding to the owner of the electric vehicle can be any electronic device capable of Internet access, such as mobile devices, such as mobile phones, smart phones, personal digital assistants, global positioning systems, and notebook computers. In some embodiments, the mobile device can receive status information and notifications of the corresponding charging operation from the cloud management server 130 via the network 120. In some embodiments, the status information and notification may include notifying that the electric vehicle has stopped charging, notifying that the vehicle needed to be moved, and/or notifying that the charging gun of the electric vehicle charging device has been disconnected from the electric vehicle, and so on.

As mentioned above, the charging field 110 has a power limit. The server 130 can perform a load adjustment operation for the electric vehicle charging stations in the charging field 110 according to at least one energy management scheme. Specifically, the server 130 can generate an instruction and send the instruction to the respective charging station (112, 114) via the network 120 to control the charging station to output power for charging with a specified power parameter, such as a specified amperage, during a specific period of time to the electric vehicle connected to the station, or to prohibit the charging station from outputting power to the electric vehicle. It is noted that, in some embodiments, when the server 130 receives the charging requests from the charging stations, a charging scheduling operation may be performed for the charging requests. In some embodiments, the charging scheduling operation may be performed in conjunction with a time-of use (TOU) rate. For example, when the electric vehicle and the charging station are connected to each other, for example, after the charging gun is inserted into the charging port of the electric vehicle, the corresponding charging operation will not be executed immediately. The server will schedule the charging operation for the respective electric vehicles according to the TOU rate, the power limit of the charging field, and the electric vehicles that needs to be charged, determine an appropriate charging time point for each charging operation, and accordingly execute the respective charging operations with the lowest electricity cost. In some embodiments, each electric vehicle requiring charging may have its charging parameters, such as required power and/or expected stay time at the charging station. The server can also perform energy management according to the corresponding charging parameters of each electric vehicle, such as charging scheduling operations.

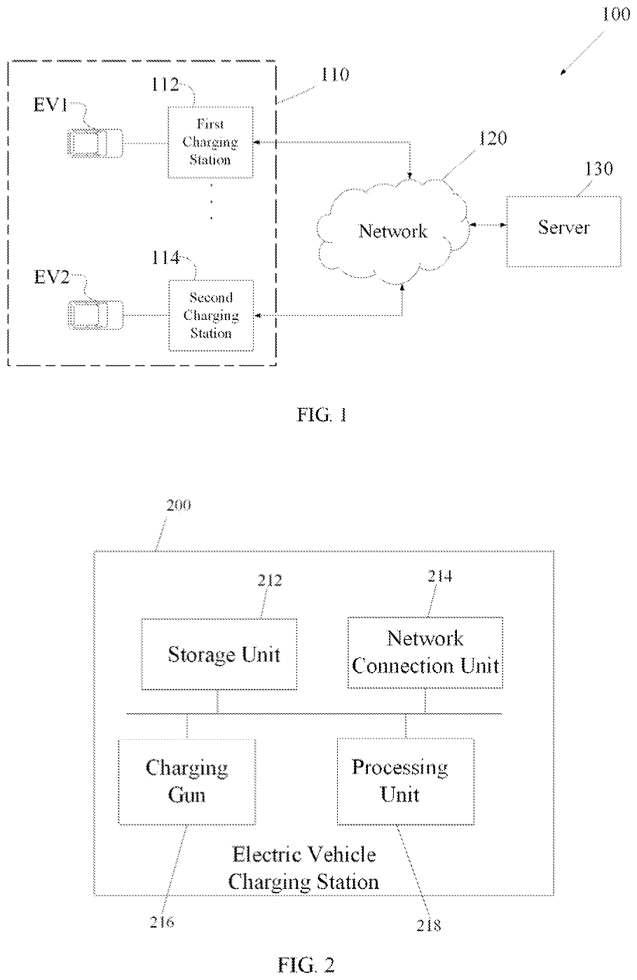

FIG. 2 is a schematic diagram illustrating an embodiment of an electric vehicle charging station of the invention. The electric vehicle charging station 200 shown in FIG. 2 can be applied to the first charging station 112 and the second charging station 114 in FIG. 1, which has processing and computing capabilities to perform charging management operations for the electric vehicle charging station. The electric vehicle charging station 200 has a network connection capability to receive, download or update various parameters and information required for charging management calculations.

The electric vehicle charging station 200 at least comprises a storage unit 212, a network connection unit 214, a charging gun 216, and a processing unit 218. The storage unit 212 may be a memory or a database for storing and recording related data. The data may be related information such as charging station ID of the electric vehicle charging station and charging requests. It should be noted that the aforementioned information is only example, and the invention is not limited thereto. The network connection unit 214 can use a network, such as a wired network, a telecommunications network, and a wireless network, such as a Wi-Fi network, to receive, download, or update various parameters and information required for charging management operations. The charging gun 216 may include one or more charging connectors that meet the same charging interface specification or meet different charging interface specifications, and are electrically connected to the corresponding electric vehicle. The processing unit 218 can control the operations of related software and hardware in the electric vehicle charging station 200, and cooperate with the server 130 to execute the methods of the invention. Related details will be described later. It is noted that, in some embodiments, the processing unit 218 may be a general-purpose controller, a Micro-Control Unit, MCU, or a Digital Signal Processor, DSP, etc., to provide functions of data analysis, processing and calculation, but the present invention is not limited to this. In one embodiment, the processing unit 218 may use the network connection unit 214 to transmit the power state of the corresponding electric vehicle through a network for a cloud management server, such as the cloud server 130, for subsequent charging management. In another embodiment, the processing unit 218 can obtain the power parameter of a charging operation from the server 130, determine the output power according to the power parameter received from the server 130, and output the power to at least one electric vehicle through the charging gun 216 to perform the charging operation. It is understood that, in some embodiments, the electric vehicle charging station 200 may comprise a card reading unit, such as an RFID reading unit for sensing information of a physical card, such as RFID card. The information sensed from the RFID card may be a card identification code of the physical card.

It is understood that, the electric vehicle charging station 200 has an upper power limit value and a lower power limit value. Specifically, the electric vehicle charging station 200 can use the upper power limit value as the power parameter at the highest to output power to the electric vehicle during a charging operation. On the other hand, the electric vehicle charging station 200 needs to use the lower power limit value as the power parameter at least to output power to the electric vehicle during a charging operation. It must be noted that, charging stations of different brands and models may have different upper power limit values for output power and lower power limit values for output power. The present invention is not limited to any value, and the value may be different for different charging stations.

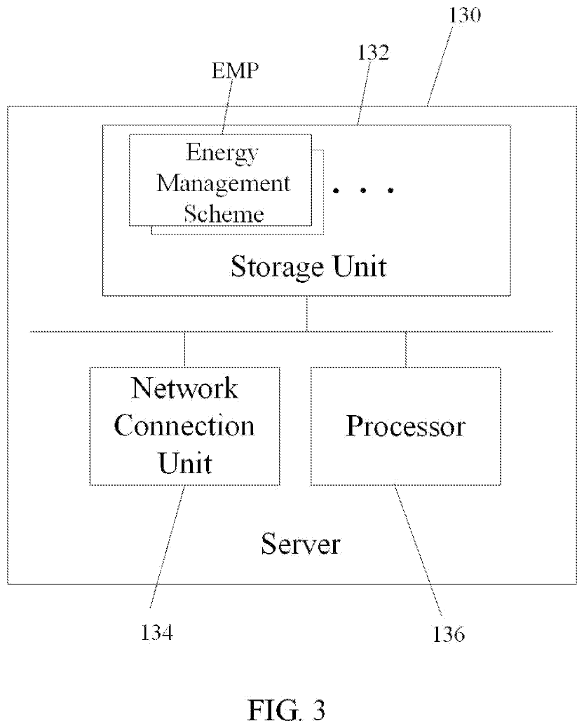

FIG. 3 is a schematic diagram illustrating an embodiment of a server of the invention. As shown in FIG. 3, the server 130 of the invention can be any processor-based electronic device, which comprises at least a storage unit 132, a network connection unit 134, and a processor 136. It is noted that, the server 130 can receive various data corresponding to a plurality of electric vehicle charging stations in a charging field. The server 130 can directly or indirectly receive a charging request from a mobile device, and after completing actions such as identity confirmation in response to the charging request, generate a charging authorization command and transmit it to the corresponding electric vehicle charging station via the network. In response to the charging authorization command, the electric vehicle charging station is allowed to output power to an electric vehicle (for example, an electric motorcycle or an electric vehicle, etc.) that is electrically connected to it, or prohibit the electric vehicle charging station from outputting power to the electric vehicle.

The storage unit 132 may be a memory, which can store and record related data, such as various data of the electric vehicle charging stations. It is noted that, the storage unit 132 may include at least one energy management scheme EMP. The energy management scheme EMP records a distribution logic for controlling a charging operation of each electric vehicle charging station. It is reminded that, the power distribution logic is configured to determine the execution order of the individual charging requests (charging operations) of the corresponding charging stations, and the corresponding target power parameter value during the respective charging operations under the power limitation of the charging field. It should be noted that, in some embodiments, the storage unit 132 may include a time setting table for setting at least one peak period and one off-peak period, and a corresponding TOU rate. Through the network connection unit 134, the server 130 can be coupled to and communicates with the electric vehicle charging stations (112, 114) via the network 120, such as a wired network, a telecommunications network, and a wireless network, such as a Wi-Fi network, and transmits related data/signals/commands to different electric vehicle charging stations via the network 120 to control whether the electric vehicle charging stations output power, and specify power parameters for outputting power to electric vehicles. The processor 136 can control the operations of related software and hardware in the server 130, and execute the methods of the invention. The relevant details will be described later. It is reminded that, when the server has multiple energy management schemes EMP, the processor 136 can select one of the energy management schemes EMP, and execute a load adjustment operation for the charging field according to the selected energy management scheme EMP. It should be noted that, in some embodiments, the processor 136 may be a general-purpose controller, a microcontroller, or a digital signal controller, etc., for providing data analysis, processing and computing functions, but the present invention is not limited to this. It should be reminded that, as mentioned above, the server may execute a charging scheduling operation for the charging requests of the electric vehicle charging stations. In some embodiments, the charging scheduling operation can be performed with the TOU rate, so that all charging operations can be performed with the lowest electricity cost. Similarly, each electric vehicle requiring charging may have its charging parameters, such as required power and/or expected stay time at the charging station. The server can also perform energy management according to the corresponding charging parameters of each electric vehicle, such as charging scheduling operations.

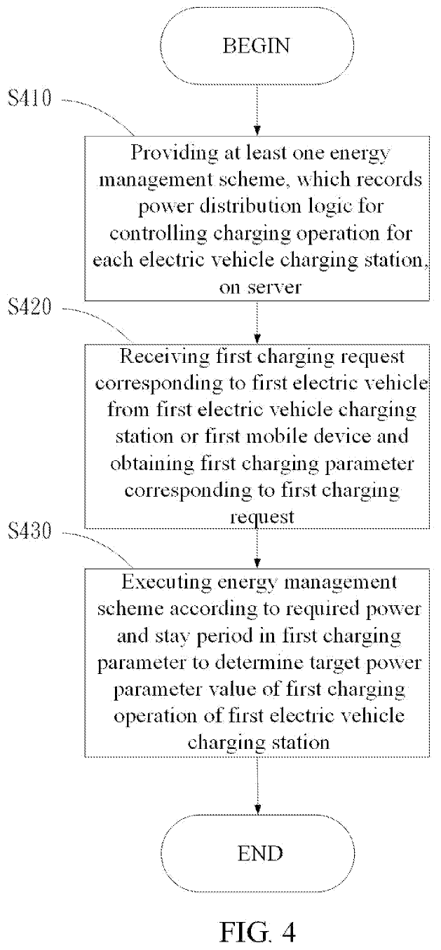

FIG. 4 is a flowchart of an embodiment of an electric vehicle charging management method based on charging demand of electric vehicle of the invention. The electric vehicle charging management method based on charging demand of electric vehicle of the invention is applicable to a charging field comprising a plurality of charging stations, and the charging field has a power limit. The respective electric vehicle charging station in the charging field can be electrically coupled with a remote server via a network.

In step S410, at least one energy management scheme is provided on the server. As mentioned, the energy management scheme may record a distribution logic to control a charging operation of each electric vehicle charging station. It is reminded that, the power distribution logic is configured to determine the execution order of the individual charging requests (charging operations) of the corresponding charging stations, and the corresponding target power parameter value during the charging operation under the power limitation of the charging field. In step S420, a first charging request corresponding to a first electric vehicle is received from a first electric vehicle charging station among the electric vehicle charging stations or a first mobile device. It is reminded that the first mobile device may be owned by the owner of the first electric vehicle. At the same time, a first charging parameter corresponding to the first charging request is obtained. It is noted that, in some embodiments, the first charging parameter may include at least a required power and/or a stay period. It is reminded that the stay period may be the time during which the first electric vehicle is expected to stay at the first electric vehicle charging station. Next, in step S430, the energy management scheme is executed according to the required power and the stay period corresponding to the first charging parameter to determine a target power parameter value of a first charging operation of the first electric vehicle charging station. It should be noted that the first electric vehicle charging station may output power to the first electric vehicle according to the target power parameter value. Note that the first charging operation is performed during the aforementioned stay period, and the total power output from the first electric vehicle charging station to the first electric vehicle is greater than the required power.

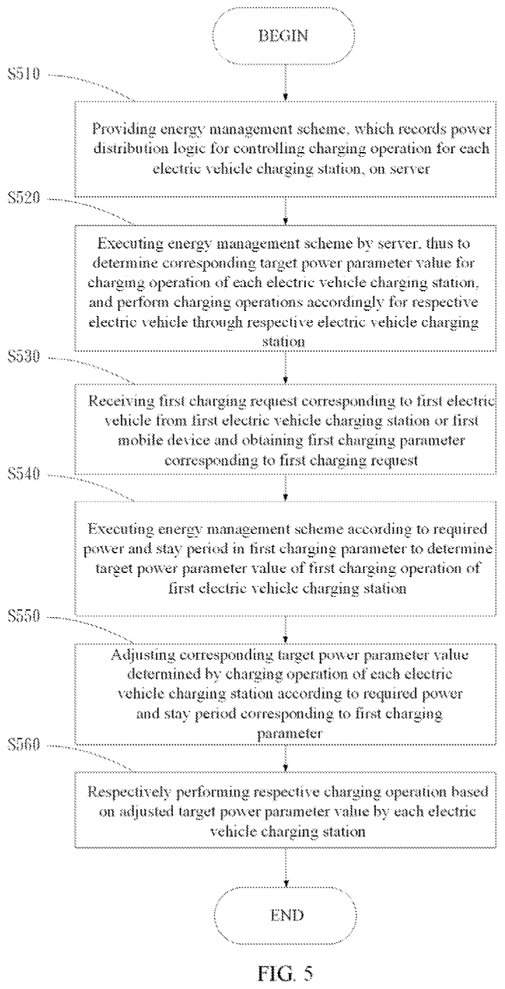

FIG. 5 is a flowchart of another embodiment of an electric vehicle charging management method based on charging demand of electric vehicle of the invention. The electric vehicle charging management method based on charging demand of electric vehicle of the invention is applicable to a charging field comprising a plurality of charging stations, and the charging field has a power limit. The respective electric vehicle charging station in the charging field can be electrically coupled with a remote server via a network.

First, in step S510, at least one energy management scheme is provided on the server. As mentioned, the energy management scheme may record a distribution logic to control a charging operation of each electric vehicle charging station. It is reminded that, the power distribution logic is configured to determine the execution order of the individual charging requests (charging operations) of the corresponding charging stations, and the corresponding target power parameter value during the charging operation under the power limitation of the charging field. In step S520, the server executes the energy management scheme to determine a target power parameter value for the charging operation of each electric vehicle charging station, and accordingly perform the charging operations for the coupled electric vehicles via the respective electric vehicle charging stations. For example, when the total number of the electric vehicle charging stations that need to perform charging operations multiplied by the power upper limit value of individual electric vehicle charging stations is greater than the power limit of the charging field, the power (target power parameter value) of each electric vehicle charging station will be scaled down, so that the total output power does not exceed the power limit of the charging field. Then, in step S530, a first charging request corresponding to a first electric vehicle is received from a first electric vehicle charging station among the electric vehicle charging stations or a first mobile device. It is reminded that the first mobile device may be owned by the owner of the first electric vehicle. At the same time, a first charging parameter corresponding to the first charging request is obtained. It is noted that, in some embodiments, the first charging parameter may include at least a required power and/or a stay period. It is reminded that the stay period may be the time during which the first electric vehicle is expected to stay at the first electric vehicle charging station. Next, in step S540, the energy management scheme is executed according to the required power and the stay period corresponding to the first charging parameter to determine a target power parameter value of a first charging operation of the first electric vehicle charging station. It should be noted that the first electric vehicle charging station may output power to the first electric vehicle according to the target power parameter value. Note that the first charging operation is performed during the aforementioned stay period, and the total power output from the first electric vehicle charging station to the first electric vehicle is greater than the required power. Then, in step S550, the corresponding target power parameter value determined by the charging operation of each electric vehicle charging station is adjusted according to the required power and the stay period corresponding to the first charging parameter, and in step S560, each electric vehicle charging station respectively performs the respective charging operation based on the adjusted target power parameter values.

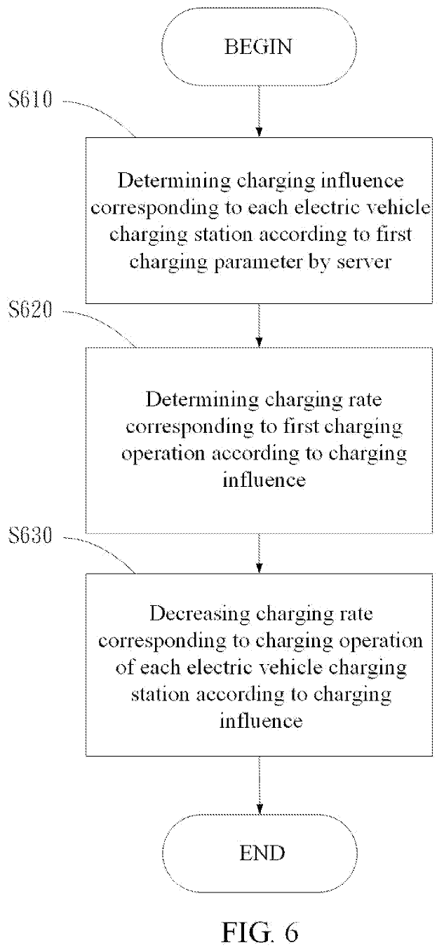

FIG. 6 is a flowchart of another embodiment of an electric vehicle charging management method based on charging demand of electric vehicle of the invention. In this embodiment, when the first charging operation of the first electric vehicle charging station is performed according to its first charging parameter, the charging rates of the respective charging operations of different electric vehicle charging stations can be dynamically adjusted.

First, in step S610, a charging influence corresponding to each electric vehicle charging station is determined according to the first charging parameter. It is noted that, in some embodiments, the charging influence includes at least a reduction in power of the charging operation corresponding to each electric vehicle charging station, and/or a delay in the charging start time. Next, in step S620, a charging rate corresponding to the first charging operation is determined according to the aforementioned charging influence. Next, in step S630, the charging rate of the charging operation of each electric vehicle charging station is decreased according to the charging influence.

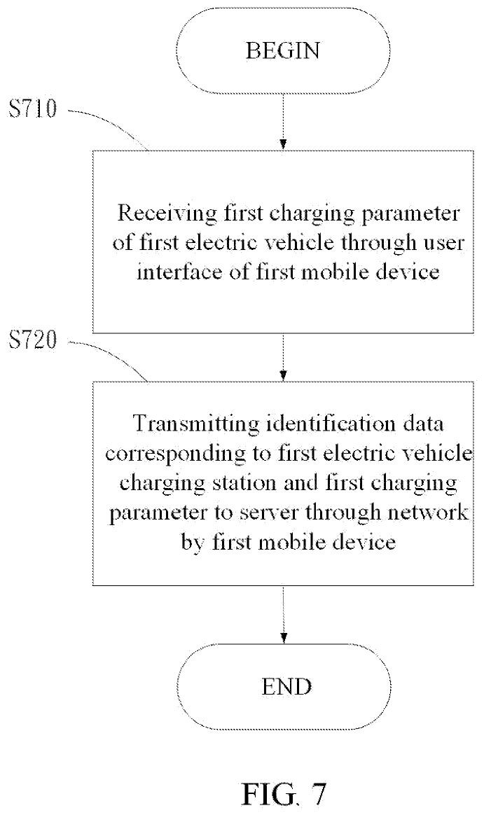

FIG. 7 is a flowchart of an embodiment of a method for obtaining charging parameters of the invention.

In step S710, a first charging parameter of the first electric vehicle is received through a user interface of the first mobile device. For example, the first mobile device may display a user interface to prompt the owner of the first electric vehicle to input the required power and the stay period. Then, in step S720, the first mobile device transmits the identification data of the first electric vehicle charging station and the first charging parameter to the server through the network.

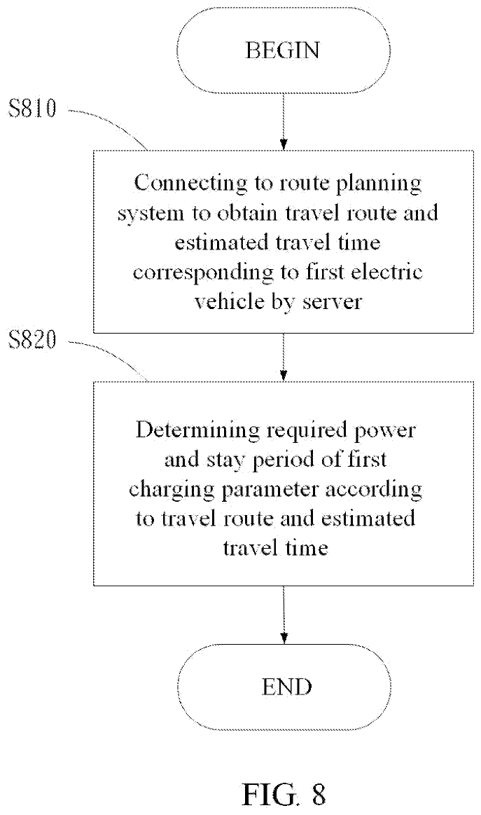

FIG. 8 is a flowchart of another embodiment of a method for obtaining charging parameters of the invention. In this embodiment, the charging parameter can be calculated based on a predetermined driving route of the first electric vehicle. In one example, the electric vehicle charging station in the charging field can be provided to a logistics operator for charging the electric vehicles it distributes goods.

When the server receives the charging request of the first electric vehicle, in step S810, the server connects to a route planning system to obtain a travel route and an estimated travel time corresponding to the first electric vehicle. Next, in step S820, according to the travel route and the estimated travel time, the required power and the stay period of the first charging parameter are determined. The obtained charging parameters can be used for subsequent energy management and charging scheduling.

It must be noted that, in some embodiments, the charging rate and the adjustment cost calculated by the server can be provided to an electric vehicle owner or a charging field operator, such as a logistics operator, to evaluate the impact of the specific charging demand, so as to make subsequent adjustments in business execution decision making. Therefore, through the electric vehicle charging management methods and systems based on charging demand of electric vehicle of the invention, it is possible to provide flexible charging schedule for electric vehicle charging management operations according to specific charging demands, and further increase the flexibility of the load adjustment and/or schedule charging operations in individual charging fields.

Electric vehicle charging management methods based on charging demand of electric vehicle, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. An electric vehicle charging management method based on charging demand of electric vehicle, which is applicable to a charging field including a plurality of electric vehicle charging stations, and the electric vehicle charging stations are connected to a server through a network, comprising:
providing at least one energy management scheme on the server, wherein the energy management scheme records a power distribution logic for controlling a charging operation for each of the electric vehicle charging stations;
receiving a first charging request corresponding to a first electric vehicle from a first electric vehicle charging station among the electric vehicle charging stations or a first mobile device and obtaining a first charging parameter corresponding to the first charging request, wherein the first charging parameter includes at least a required power and a stay period; and
executing the energy management scheme according to the required power and the stay period to determine a target power parameter value of a first charging operation of the first electric vehicle charging station, wherein the first electric vehicle charging station outputs power to the first electric vehicle based on the target power parameter value,
wherein the first charging operation is performed during the stay period, and the total power output from the first electric vehicle charging station to the first electric vehicle is greater than the required power.

2. The method of claim 1, further comprising:
executing the energy management scheme by the server, thus to determine the corresponding target power parameter value for the charging operation of each electric vehicle charging station, and perform the charging operations accordingly for respective electric vehicles through the respective electric vehicle charging stations;
adjusting the corresponding target power parameter value determined by the charging operation of each electric vehicle charging station according to the required power and the stay period corresponding to the first charging parameter; and
respectively performing the respective charging operation based on the adjusted target power parameter value by each electric vehicle charging station.

3. The method of claim 1, further comprising:
determining a charging influence corresponding to each electric vehicle charging station according to the first charging parameter by the server, wherein the charging influence includes at least a reduction in power of the charging operation corresponding to each electric vehicle charging station; and
determining a charging rate corresponding to the first charging operation according to the charging influence.

4. The method of claim 3, further comprising a step of decreasing the charging rate corresponding to the charging operation of each electric vehicle charging station according to the charging influence.

5. The method of claim 1, further comprising:
receiving the first charging parameter of the first electric vehicle through a user interface of the first mobile device; and
transmitting identification data corresponding to the first electric vehicle charging station and the first charging parameter to the server through the network by the first mobile device.

6. The method of claim 1, further comprising:
connecting to a route planning system to obtain a travel route and an estimated travel time corresponding to the first electric vehicle by the server; and
determining the required power and the stay period of the first charging parameter according to the travel route and the estimated travel time.

7. An electric vehicle charging management system based on charging demand of electric vehicle for use in a charging field, comprising:
a plurality of electric vehicle charging stations, each having a network connecting capability; and
a server having at least one energy management scheme, which records a power distribution logic for controlling a charging operation for each of the electric vehicle charging stations, receiving a first charging request corresponding to a first electric vehicle from a first electric vehicle charging station among the electric vehicle charging stations or a first mobile device and obtaining a first charging parameter corresponding to the first charging request, wherein the first charging parameter includes at least a required power and a stay period, and executing the energy management scheme according to the required power and the stay period to determine a target power parameter value of a first charging operation of the first electric vehicle charging station, wherein the first electric vehicle charging station outputs power to the first electric vehicle based on the target power parameter value, wherein the first charging operation is performed during the stay period, and the total power output from the first electric vehicle charging station to the first electric vehicle is greater than the required power.

8. The system of claim 7, wherein the server further executes the energy management scheme, thus to determine the corresponding target power parameter value for the charging operation of each electric vehicle charging station, and perform the charging operations accordingly for respective electric vehicles through the respective electric vehicle charging stations, and adjusts the corresponding target power parameter value determined by the charging operation of each electric vehicle charging station according to the required power and the stay period corresponding to the first charging parameter, wherein each electric vehicle charging station respectively performs the respective charging operation based on the adjusted target power parameter value.

9. The system of claim 8, wherein the server further determines a charging influence corresponding to each electric vehicle charging station according to the first charging parameter, wherein the charging influence includes at least a reduction in power of the charging operation corresponding to each electric vehicle charging station, and determines a charging rate corresponding to the first charging operation according to the charging influence.

10. The system of claim 9, wherein the server further decreases the charging rate corresponding to the charging operation of each electric vehicle charging station according to the charging influence.

11. The system of claim 7, wherein the first mobile device further receives the first charging parameter of the first electric vehicle through a user interface, and transmits identification data corresponding to the first electric vehicle charging station and the first charging parameter to the server through the network.

12. The system of claim 7, wherein the server further connects to a route planning system to obtain a travel route and an estimated travel time corresponding to the first electric vehicle, and determines the required power and the stay period of the first charging parameter according to the travel route and the estimated travel time.

13. A machine-readable storage medium comprising a computer program, which, when executed, causes a device to perform an electric vehicle charging management method based on charging demand of electric vehicle, which is applicable to a charging field including a plurality of electric vehicle charging stations, and the electric vehicle charging stations are connected to a server through a network, wherein the method comprises:
providing at least one energy management scheme on the server, wherein the energy management scheme records a power distribution logic for controlling a charging operation for each of the electric vehicle charging stations;
receiving a first charging request corresponding to a first electric vehicle from a first electric vehicle charging station or a first mobile device and obtaining a first charging parameter corresponding to the first charging request, wherein the first charging parameter includes at least a required power and a stay period; and
executing the energy management scheme according to the required power and the stay period to determine a target power parameter value of a first charging operation of the first electric vehicle charging station, wherein the first electric vehicle charging station outputs power to the first electric vehicle based on the target power parameter value,
wherein the first charging operation is performed during the stay period, and the total power output from the first electric vehicle charging station to the first electric vehicle is greater than the required power.
